(19) United States
(12) Patent Application Publication
(10) Pub. No.: US 2022/0350021 A1
(43) Pub. Date: Nov. 3, 2022

(54) END-FIRE SYNTHETIC APERTURE SONAR

(71) Applicant: University of New Hampshire, Durham, NH (US)

(72) Inventors: Shannon-Morgan Steele, Dover, NH (US); Anthony P. Lyons, Durham, NH (US)

(73) Assignee: University of New Hampshire, Durham, NH (US)

(21) Appl. No.: 17/435,738

(22) PCT Filed: Mar. 5, 2020
(86) PCT No.: PCT/US2020/021087

§ 371 Date: Sep. 2, 2021

Related U.S. Application Data
(60) Provisional application No. 62/814,584, filed on Mar. 6, 2019.

(51) Int. Cl. G01S 15/89; G01S 7/527; G01S 15/10

(52) U.S. Cl. CPC G01S 15/8904; G01S 7/527; G01S 15/101

(57) ABSTRACT

Techniques are provided for implementing an end-fire synthetic aperture sonar system. A methodology implementing the techniques according to an embodiment includes generating a plurality of matched-filtered signals (pings) based on correlations of a transmitted sonar signal with a plurality of reflected or scattered returns of the transmitted signal received from a hydrophone, the reflected or scattered returns associated with a plurality of locations of the hydrophone relative to a location of a transmitter. The method further includes generating a coarse estimate of the locations of the hydrophone based on incoherent cross correlations of the pings, and generating a refined estimate of the locations of the hydrophone based on the coarse estimate and further based on coherent cross correlations of the pings. The method further includes performing delay-and-sum beamforming to combine the pings, the beamforming employing time delays based on the estimated locations of the hydrophone.

### CROSS-REFERENCE TO RELATED APPLICATIONS

This application claims benefit under 35 U.S.C. § 371 as a national stage application of PCT Application No. PCT/US2020/021087, filed Mar. 5, 2020. PCT Application No. PCT/US2020/021087 claims priority to U.S. Provisional Patent Application No. 62/814,584, filed Mar. 6, 2019. Each of these related applications is hereby incorporated herein by reference in its entirety.

### BACKGROUND

Seafloor characterization is of great interest for a variety of purposes including habitat mapping, resource extraction, object detection, and ocean engineering. Direct measurements of seafloor and sub-bottom sediment properties require a ship to stop to acquire sediment cores. Such point samples are expensive and time consuming to collect over large areas, and can rarely be obtained frequently enough to adequately sample rapidly varying seafloor sediments. Remote sensing is a viable alternative seafloor characterization method; however, terrestrial remote sensing methods such as radar and LiDAR (Light Detection and Ranging) are of limited use in deep water, and thus, sonar is the typical sensing method for most seafloor and sub-bottom characterization studies.

Higher-frequency sonar systems can achieve narrower beamwidths, and therefore provide greater angular resolution, but unfortunately, the higher frequencies are subject to greater attenuation and suffer from reduced propagation ranges which limit their effectiveness for seafloor characterization. Lower-frequency sonar systems provide better propagation ranges but are generally limited by broader beamwidths.

### BRIEF DESCRIPTION OF THE DRAWINGS

FIG. 1 illustrates a comparison of a low-frequency transmitter (such as an echo sounder or sub-bottom profiler) and an end-fire synthetic aperture sonar (SAS), configured in accordance with certain embodiments of the present disclosure.

FIG. 2 illustrates time delay beamforming, in accordance with certain embodiments of the present disclosure.

FIG. 3 illustrates an end-fire SAS deployment, in accordance with certain embodiments of the present disclosure.

FIG. 4 is a block diagram of an end-fire SAS processor, configured in accordance with certain embodiments of the present disclosure.

FIG. 5 is a block diagram of a scattered field navigation circuit, configured in accordance with certain embodiments of the present disclosure.

FIG. 6 is a flowchart illustrating a methodology for end-fire SAS signal processing, in accordance with certain embodiments of the present disclosure.

FIG. 7 is a block diagram schematically illustrating a platform configured to implement an end-fire SAS, in accordance with certain embodiments of the present disclosure.

Although the following Detailed Description will proceed with reference being made to illustrative embodiments, many alternatives, modifications, and variations thereof will be apparent in light of this disclosure.

### DETAILED DESCRIPTION

Techniques are provided for an end-fire synthetic aperture sonar (SAS), configured to operate at lower frequencies for improved signal propagation, while still providing the increased angular resolution associated with a narrower beamwidth. As previously noted, sonar is typically an effective sensing method for most seafloor and sub-bottom characterization studies. While lower-frequency sonar systems provide better propagation ranges (with less signal attenuation) than higher-frequency systems, the achievable angular resolution of such systems is generally limited by the broader beamwidths associated with existing low frequency beamforming techniques. To this end, an example embodiment of the present disclosure provides a methodology for end-fire SAS, which forms a synthetic sensor array in the vertical direction (from sea surface to seafloor) by dropping a transmitter and/or receiver through the water column, as will be explained in greater detail below. An example system for carrying out the methodology is also provided.

The disclosed techniques can be implemented, for example, in a computing system or a software product executable or otherwise controllable by such systems, although other embodiments will be apparent. The system or product is configured to implement an end-fire SAS. In accordance with such an embodiment, a methodology to implement these techniques includes generating a plurality of matched-filtered signals (pings) based on correlations of a transmitted sonar signal with a plurality of reflected or scattered returns of the transmitted signal received from a hydrophone, the reflected or scattered returns associated with a plurality of locations of the hydrophone relative to a location of the transmitter. The method further includes generating a coarse estimate of the locations of the hydrophone based on incoherent cross correlations of the pings, and generating a refined estimate of the locations of the hydrophone based on the coarse estimate and further based on coherent cross correlations of the pings. The method further includes performing delay-and-sum beamforming to combine the pings to generate a beam informed signal, the beamforming employing time delays based on the estimated locations of the hydrophone.

As will be appreciated, the techniques described herein may provide improved remote sensing angular resolution for seafloor and sub-bottom characterization, compared to existing techniques that do not benefit from the narrower beamwidth obtained from synthetic aperture beamforming or that require multiple receivers and relatively expensive motion sensors. The disclosed techniques can be implemented on a broad range of platforms including workstations, laptops, tablets, and other general purpose or application specific computing devices. These techniques may further be implemented in hardware or software or a combination thereof.

General Overview

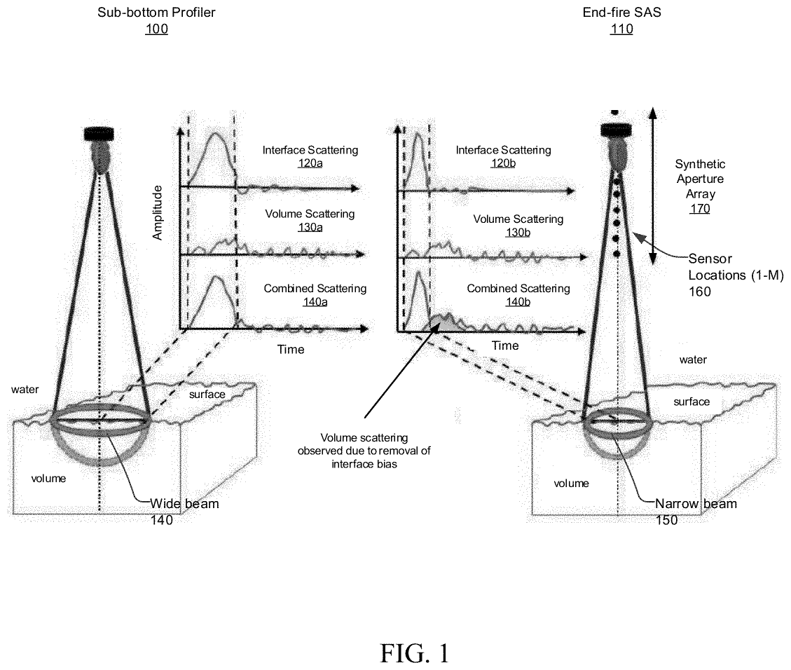

FIG. 1 illustrates a comparison of a low-frequency transmitter (such as a sub-bottom profiler) 100 and an end-fire synthetic aperture sonar (SAS) 110, configured in accordance with certain embodiments of the present disclosure. The sub-bottom profiler 100 transmits a relatively low frequency signal (e.g., less than 15 kHz) down through the water and listens for (e.g., receives) a signal that includes reflections and scattering from the seafloor surface (also referred to as interface scattering), as well as reflections and scattered returns from the subsurface (also referred to as volume scattering). Plots of the received signal are shown where the interface scattering 120a and the volume scattering 130a are broken out, for illustration, from the combined scattering 140a of the received signal. The low-frequency and corresponding wide beamwidth 140 (illustrated by the circle) provide a relatively low angular resolution.

In comparison, the end-fire SAS system 110, in this example, employs a single sensor (e.g., hydrophone) that is repositioned at multiple (M) locations 160 along the axis of transmission (e.g., in an end-fire configuration) to create a long baseline synthetic aperture array 170 which decreases the beamwidth to a narrow beam 150, as shown by the smaller circle, while employing a low-frequency signal similar to that of the sub-bottom profiler 100. As can be seen, the interface scattering return 120b is narrower, and the resulting volume scattering 130b can be more easily discerned from the combined scattering signal 140b.

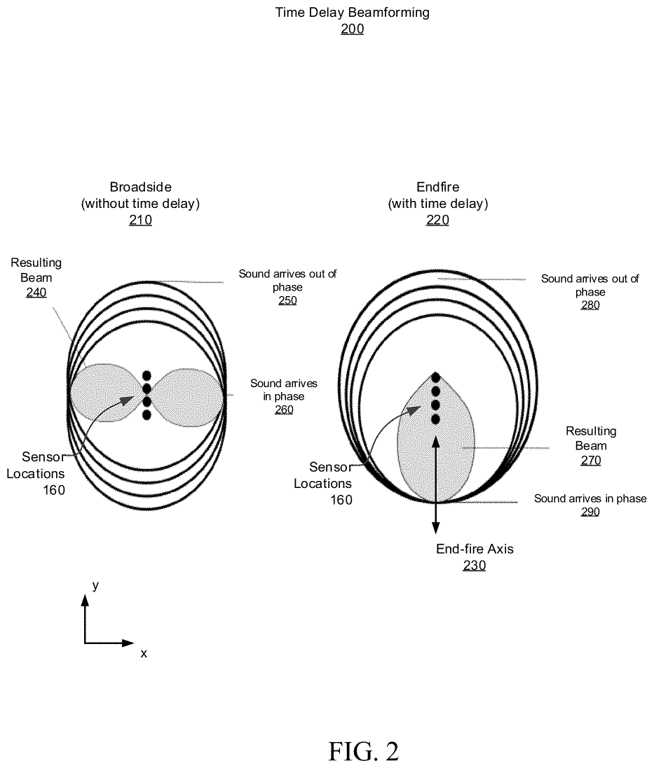

FIG. 2 illustrates time-delay beamforming (also referred to as delay-and-sum beamforming) 200, in accordance with certain embodiments of the present disclosure. A broadside configuration 210 (without using time delay) is shown on the left side of the figure, for comparison with the end-fire configuration 220 on the right side of the figure. In the broadside configuration 210, sensors are arranged in a linear array along the y-axis at locations 160, and without time delay, form a resulting beam pattern 240, directed along both directions of the x-axis. This is due to the fact that soundwaves impinging on the sensors from the left and the right (i.e., along the x-axis) arrive in phase 260 and sum constructively, as opposed to soundwaves coming in from the top and bottom (i.e., along the y-axis), which arrive out of phase 250 and destructively interfere with one another.

In contrast, the end-fire configuration 220 time shifts the received signal at each sensor so that soundwaves arriving from below (i.e., along the y-axis) arrive in phase 290 and sum constructively to form a resulting beam pattern 270 pointing downward along the end-fire axis 230. Soundwaves arriving from other directions are shifted out of phase 280, as a result of the applied time delay, and destructively interfere with one another. In general, the beamwidth depends on a number of factors, including the frequency of the signal, the number of sensors, the relative sensor positions, and aperture length. As will be explained below, a synthetic aperture sonar system may employ a single sensor located at different positions at different times, with suitable signal processing techniques, to simulate an array of multiple sensors.

System Architecture

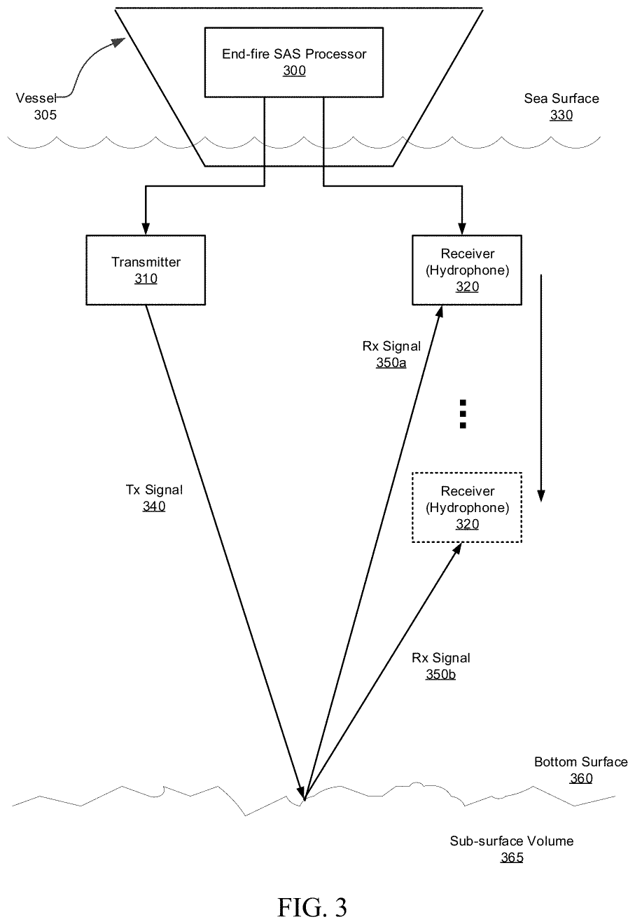

FIG. 3 illustrates an end-fire SAS deployment, in accordance with certain embodiments of the present disclosure. An end-fire SAS processor 300 is shown to be deployed in a ship or other suitable vessel 305 on the surface of a body of water 330. The operation of the end-fire SAS processor 300 will be described in greater detail below. The processor 300 is coupled to a transmitter 310 and a receiver or sensor (e.g., hydrophone) 320, both of which are deployed below the water surface. The transmitter 310 is configured to transmit a series of sonar signals 340 at periodic intervals which propagate down toward the bottom surface 360 and sub-surface volume 365. In some embodiments, the transmitted signal 340 may be a frequency swept signal, also referred to as a frequency chirp. The frequency range of the chirp can be relatively low, allowing for improved propagation in water and sub-surface volume. In some embodiments, the frequency may range from approximately 5 kHz to 10 kHz.

The transmitted signals 340 are scattered off the bottom surface 360 as well as the subsurface volume 365. The hydrophone 320 and/or transmitter 310 may be lowered to a desired number of depth levels to receive the scattered signals 350a, 350b, . . . etc., over a period of time. The synthetic aperture sonar is synthesized over a baseline in which the receiver and/or transmitter is positioned at these various locations during a sequence of time intervals.

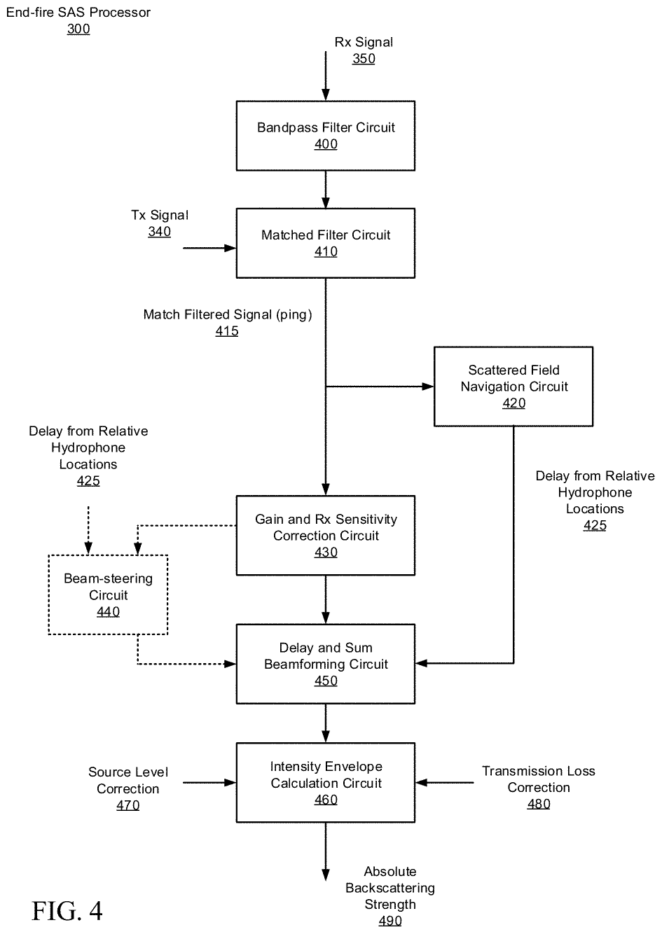

FIG. 4 is a block diagram of an end-fire SAS processor 300, configured in accordance with certain embodiments of the present disclosure. The SAS processor 300 is shown to include a bandpass-filter circuit 400, a matched-filter circuit 410, a scattered-field navigation circuit 420, a gain and receiver-sensitivity correction circuit 430, an optional beam-steering circuit 440, a delay-and-sum beamforming circuit 450, and an intensity-envelope calculation circuit 460.

The bandpass-filter circuit 400 is configured to reduce noise in the received signals by filtering out energy that lies outside of the frequency band of the transmitted signal.

The matched-filter circuit 410 is configured to generate matched-filtered signals (referred to herein as pings) by correlating the transmitted sonar signal with the reflected or scattered returns of the transmitted signal received from the hydrophone at each position along the end-fire axis.

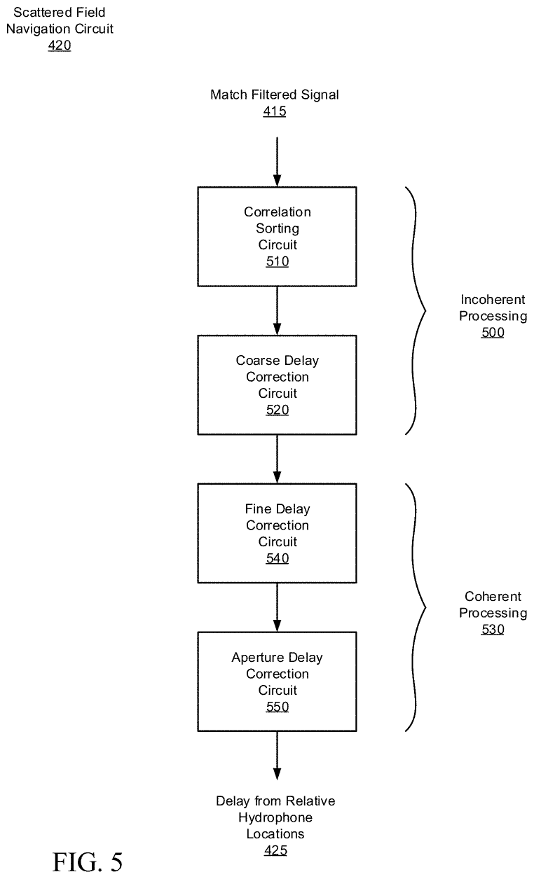

The scattered-field navigation circuit 420 is configured to estimate the relative location of the hydrophone 320 for each received signal and the associated delay 425. The delay 425, associated with the relative locations of the hydrophone, are needed to perform the time-delay based beamforming described below. Operation of the scattered field navigation circuit 420 is described in greater detail below in connection with FIG. 5, but at a high-level, the seafloor acoustic response is used to navigate the system (e.g., determine platform motion between pings to locate the hydrophone) with sufficient accuracy to beamform and beamsteer correctly. This avoids the need for relatively expensive motion sensors and/or the use of multiple receivers.

The gain and receiver-sensitivity correction circuit 430 is configured to calibrate the gain and sensitivity of the hydrophone receiver 320, using known techniques in light of the present disclosure.

The optional beam-steering circuit 440 is configured to steer the beam off of the end-fire axis (e.g., away from the normal angle of incidence), for situations where this may be desired. Beam steering is accomplished by delaying the signals from each hydrophone element (which, for a SAS, is the same hydrophone at a different location at a different time) by a value τₘ that is a function of the steering angle θ. This can be expressed by the following equation:

$${τ}_{m} = \frac{( {r}_{m} - {r}_{1} ) sin θ}{c}$$

where is m is the hydrophone element (m=1: M), r is the range of the receiver from the sediment interface (e.g., bottom surface), and c is the speed of sound in water.

The delay-and-sum beamforming circuit 450 is configured to form a beam by delaying all received signals relative to the hydrophone position that is furthest away from the sediment interface, summed, and then divided by the number of pings (e.g., to normalize the received uncalibrated intensity).

The intensity-envelope calculation circuit 460 is configured to calculate the intensity envelope of the beamformed (and optionally beamsteered) signal, I_{RL}(t), taking into account corrections for the source levels 470 and transmission losses 480. The absolute back-scattering strength Sₛ (t) 490, is then determined from the intensity envelope, for example, according to the following equation:

$${S}_{s} ( t ) = \frac{{I}_{RL} ( t ) α ( t ) {r}^{4} ( t )}{{I}_{SL} ( t ) V ( t )}$$

where I_{SL}(t) is the intensity envelope of the source level, α(t) is the attenuation coefficient in the water column and surface volume, r is the range from the hydrophone to the sediment interface, and Vis the ensonified volume.

FIG. 5 is a block diagram of the scattered-field navigation circuit 420, configured in accordance with certain embodiments of the present disclosure. The scattered-field navigation circuit 420 is shown to include an incoherent processing stage 500 comprising a correlation-sorting circuit 510 and a coarse-delay correction circuit 520. The scattered-field navigation circuit 420 is shown to further include a coherent processing stage 530 comprising a fine-delay correction circuit 540 and an aperture-delay correction circuit 550. The incoherent processing stage 500 operates on the magnitude or absolute value of the signal correlations. The coherent-processing stage 530 operates on the complex-valued signal correlations to use the phase information to fine tune the delays.

The correlation-sorting circuit 510 is configured to generate a correlation matrix that is formed by incoherently cross-correlating each ping with a set of pings that represent the full depth of the water-column. The maximum of each cross-correlation is recorded in the matrix which allows the pings to be grouped and sorted based on other pings with which they are most strongly correlated. This correlation sorting is performed incoherently because when the depth of the EF-SAS system varies rapidly, the phase of the sediment response will wrap multiple times, rendering the information meaningless until the phase is unwrapped or the pings are sorted such that pings near the same range from the seafloor can be compared. For this step, using coherent correlations instead of incoherent correlations degrades the efficiency of the correlation sorting because the coherent correlations cannot consistently track ping positions.

The coarse delay correction circuit 520 is configured to use the maxima of the sediment return signal to estimate the range to the sediment interface. A time delay is then applied to each ping, aligning them such that the sediment response for each ping appears at the same time. Based on these estimates to the bottom, these pings are then sorted as closest to furthest away from the sediment.

The fine delay correction circuit 540 is configured to separate the pings into groups of a selected size. Each ping in a group is correlated against the first ping in the group (referred to here as group reference ping) and then delayed the corresponding number of lags (according to the correlation maxima), and then resorted. A successful execution of the correlation sorting and coarse delay will result in the small groups of pings being close enough together in space so that the phase delay is unambiguous. The selected number of pings in a group is dependent on the number of times the EF-SAS system is moved through the water column and the distance between pings. In some embodiments, the group size is eight pings because: 1) the EF-SAS system is lowered and raised through the water column four times, thus the position of the EF-SAS system returns to nearly the same point eight times, and 2) the average ping spacing is 0.1λ of the center frequency of the transmitted signal and thus groups of eight pings should generally be less than one wavelength apart. In some embodiments, larger or smaller groups sizes may also be used.

The aperture-delay correction circuit 550 is configured to apply an aperture delay to each individual synthetic aperture that is formed, to ensure alignment of all of the groups within an aperture. For this process, the group reference pings of the groups included in the synthetic aperture are coherently correlated with an individual ping in the aperture to align the groups and refine the ping positions and thus the relative locations of the hydrophones. In some embodiments, the individual ping chosen for the aperture delay process may be the ping at the bottom of the aperture.

Methodology

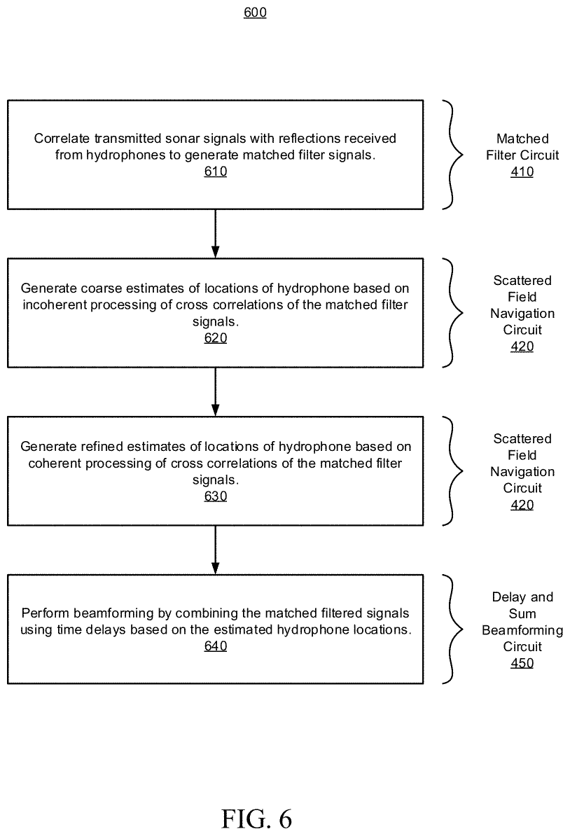

FIG. 6 is a flowchart illustrating an example method 600 for end-fire SAS signal processing, in accordance with certain embodiments of the present disclosure. As can be seen, the example method includes a number of phases and sub-processes, the sequence of which may vary from one embodiment to another. However, when considered in the aggregate, these phases and sub-processes form a process for end-fire SAS signal processing, in accordance with certain of the embodiments disclosed herein. These embodiments can be implemented, for example, using the system architecture illustrated in FIGS. 1-5, as described above. However other system architectures can be used in other embodiments, as will be apparent in light of this disclosure. To this end, the correlation of the various functions shown in FIG. 6 to the specific components illustrated in the other figures is not intended to imply any structural and/or use limitations. Rather, other embodiments may include, for example, varying degrees of integration wherein multiple functionalities are effectively performed by one system. For example, in an alternative embodiment a single module having decoupled sub-modules can be used to perform all of the functions of method 600. Thus, other embodiments may have fewer or more modules and/or sub-modules depending on the granularity of implementation. In still other embodiments, the methodology depicted can be implemented as a computer program product including one or more non-transitory machine-readable mediums that when executed by one or more processors cause the methodology to be carried out. Numerous variations and alternative configurations will be apparent in light of this disclosure.

As illustrated in FIG. 6, in an embodiment, method 600 for end-fire SAS signal processing commences by generating, at operation 610, a plurality of matched-filtered signals (pings) based on correlations of a transmitted sonar signal with a plurality of scattered returns of the transmitted signal received from a hydrophone. The scattered returns are associated with a plurality of locations of the hydrophone relative to a location of a transmitter.

Next, at operation 620, a coarse estimate of the locations of the hydrophone is generated based on incoherent cross correlations of the pings. In some embodiments, the coarse estimate may be generated by: sorting the pings based on maximum values of the incoherent cross correlations; estimating a seafloor range based on the maximum values; applying time delays to align the pings based on the estimated seafloor range; and sorting the aligned pings based on estimated distance to the seafloor.

At operation 630, a refined estimate of the locations of the hydrophone is generated based on the coarse estimate and further based on coherent cross correlations of the pings. In some embodiments, the refined estimate may be generated by: delaying groups of the coherently cross-correlated pings to a lag number corresponding to a maximum of the coherent cross-correlations; performing a second coherent cross-correlation between one of the sorted pings that is estimated closest to the seafloor, and the remainder of the sorted pings; and delaying the coherently cross-correlated pings to a lag number corresponding to a maximum of the second coherent cross-correlation.

At operation 640, delay-and-sum beamforming is performed to combine the pings to generate a beamformed signal. The beamforming employs time delays based on the estimated locations of the hydrophone.

Of course, in some embodiments, additional operations may be performed, as previously described in connection with the system. For example, the received signals may be bandpass filtered to reduce noise. In some embodiments the transmitted sonar signal may be a frequency swept signal ranging from a first frequency to a second frequency and the bandpass filter may be configured to pass signals in that frequency range (e.g., from first frequency to second frequency). In some embodiments, the beam may be steered to selected alternative directions (versus the end-fire axis) through the application of additional time delays to the pings.

Example System

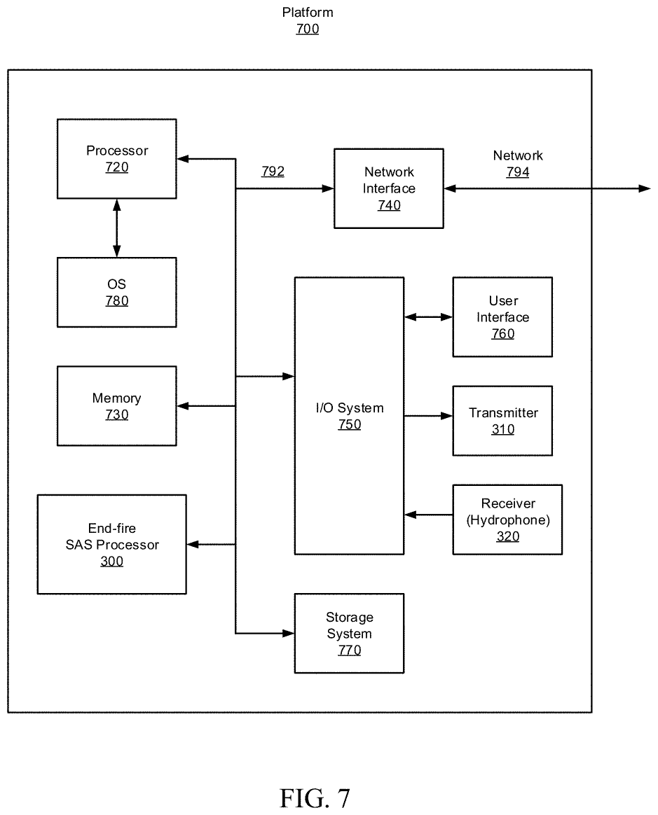

FIG. 7 illustrates an example platform 700, configured in accordance with certain embodiments of the present disclosure, to implement an end-fire SAS system. In some embodiments, platform 700 may be hosted on, or otherwise be incorporated into a personal computer, workstation, server system, embedded system, and so forth. In some embodiments, platform 700 may be deployed on ship or other vessel configured to deploy a transmitter and receiver below the water surface. Any combination of different devices may be used in certain embodiments.

In some embodiments, platform 700 may comprise any combination of a processor 720, a memory 730, end-fire SAS processor, a network interface 740, an input/output (I/O) system 750, a user interface 760, a sonar transmitter 310, a sonar receiver (e.g., hydrophone) 320, and a storage system 770. As can be further seen, a bus and/or interconnect 792 is also provided to allow for communication between the various components listed above and/or other components not shown. Platform 700 can be coupled to a network 794 through network interface 740 to allow for communications with other computing devices, platforms, devices to be controlled, or other resources. Other componentry and functionality not reflected in the block diagram of FIG. 7 will be apparent in light of this disclosure, and it will be appreciated that other embodiments are not limited to any particular hardware configuration.

Processor 720 can be any suitable processor, and may include one or more coprocessors or controllers, such as an audio processor, a graphics processing unit, or hardware accelerator, to assist in control and processing operations associated with platform 700. In some embodiments, the processor 720 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 720 may be implemented as a complex instruction set computer (CISC) or a reduced instruction set computer (RISC) processor. In some embodiments, processor 720 may be configured as an x86 instruction set compatible processor.

Memory 730 can be implemented using any suitable type of digital storage including, for example, flash memory and/or random-access memory (RAM). In some embodiments, the memory 730 may include various layers of memory hierarchy and/or memory caches as are known to those of skill in the art. Memory 730 may be implemented as a volatile memory device such as, but not limited to, a RAM, dynamic RAM (DRAM), or static RAM (SRAM) device. Storage system 770 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device.

Processor 720 may be configured to execute an Operating System (OS) 780 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), Linux, or a real-time operating system (RTOS). As will be appreciated in light of this disclosure, the techniques provided herein can be implemented without regard to the particular operating system provided in conjunction with platform 700, and therefore may also be implemented using any suitable existing or subsequently-developed platform.

Network interface circuit 740 can be any appropriate network chip or chipset which allows for wired and/or wireless connection between other components of device platform 700 and/or network 794, thereby enabling platform 700 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 750 may be configured to interface between various I/O devices and other components of device platform 700. I/O devices may include, but not be limited to, user interface 760, transmitter 310, and receiver 320. User interface 760 may include devices (not shown) such as a speaker, display element, touchpad, keyboard, and mouse, etc. I/O system 750 may include a graphics subsystem configured to perform processing of images for rendering on the display element.

It will be appreciated that in some embodiments, the various components of platform 700 may be combined or integrated in a system-on-a-chip (SoC) architecture. In some embodiments, the components may be hardware components, firmware components, software components or any suitable combination of hardware, firmware or software.

End-fire SAS processor 300 is configured to implement an end-fire synthetic aperture sonar (SAS) system, configured to operate at lower frequencies for improved signal propagation, while still providing the increased resolution associated with a narrower beamwidth, as described previously. End-fire SAS processor 300 may include any or all of the circuits/components illustrated in FIGS. 1-5, as described above. These components can be implemented or otherwise used in conjunction with a variety of suitable software and/or hardware that is coupled to or that otherwise forms a part of platform 700. These components can additionally or alternatively be implemented or otherwise used in conjunction with user I/O devices that are capable of providing information to, and receiving information and commands from, a user.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the SAS processing methodologies disclosed herein to be implemented. The instructions can be encoded using a suitable programming language, such as, for example, C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In certain embodiments, the system may leverage processing resources provided by a remote computer system accessible via network 794. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments platform 700 may comprise additional, fewer, or alternative subcomponents as compared to those included in the example embodiment of FIG. 7.

The aforementioned non-transitory computer readable medium may be any suitable medium for storing digital information, such as a hard drive, a server, a flash memory, and/or random-access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method, process, and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smart phones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Further Example Embodiments

The following examples pertain to further embodiments, from which numerous permutations and configurations will be apparent.

Example 1 is an end-fire synthetic aperture sonar system, the system comprising: a matched filter circuit to generate a plurality of matched filtered signals (pings) based on correlations of a transmitted sonar signal with a plurality of scattered returns of the transmitted signal received from a hydrophone, the scattered returns associated with a plurality of locations of the hydrophone relative to a location of a transmitter; a navigation circuit to generate a coarse estimate of the locations of the hydrophone based on incoherent cross correlations of the pings; the navigation circuit further to generate a refined estimate of the locations of the hydrophone based on the coarse estimate and further based on coherent cross correlations of the pings; and a delay-and-sum beamforming circuit to combine the pings to generate a beamformed signal, the beamforming employing time delays based on the estimated locations of the hydrophone.

Example 2 includes the subject matter of Example 1, wherein the coarse estimate generation further comprises: sorting the pings based on maximum values of the incoherent cross correlations; estimating a seafloor range based on the maximum values; applying time delays to align the pings based on the estimated seafloor range; and sorting the aligned pings based on estimated distance to the seafloor.

Example 3 includes the subject matter of Examples 1 or 2, wherein the refined estimate generation further comprises: delaying groups of the coherently cross-correlated pings to a lag number corresponding to a maximum of the coherent cross-correlations; performing a second coherent cross-correlation between one of the sorted pings that is estimated closest to the seafloor, and a remainder of the sorted pings; and delaying the coherently cross-correlated pings to a lag number corresponding to a maximum of the second coherent cross-correlation.

Example 4 includes the subject matter of any of Examples 1-3, further comprising a beam-steering circuit to apply additional time delays to the pings to steer the beamformed signal in a desired direction.

Example 5 includes the subject matter of any of Examples 1-4, further comprising an intensity-envelope calculation circuit to calculate a backscattering strength of the beamformed signal based on attenuation of the beamformed signal in water and range from the estimated locations of the hydrophone to a sediment surface from which the scattered returns are reflected and scattered.

Example 6 includes the subject matter of any of Examples 1-5, wherein the transmitted sonar signal is a frequency swept signal ranging from a first frequency to a second frequency.

Example 7 includes the subject matter of any of Examples 1-6, further comprising a bandpass filter circuit to filter the plurality of scattered returns of the transmitted signal to a frequency range between the first frequency and the second frequency.

Example 8 is a method for implementing an end-fire synthetic aperture sonar, the method comprising: generating, by a processor-based system, a plurality of matched filtered signals (pings) based on correlations of a transmitted sonar signal with a plurality of scattered returns of the transmitted signal received from a hydrophone, the scattered returns associated with a plurality of locations of the hydrophone relative to a location of a transmitter; generating, by the processor-based system, a coarse estimate of the locations of the hydrophone based on incoherent cross correlations of the pings; generating, by the processor-based system, a refined estimate of the locations of the hydrophone based on the coarse estimate and further based on coherent cross correlations of the pings; and performing, by the processor-based system, delay-and-sum beamforming to combine the pings to generate a beamformed signal, the beamforming employing time delays based on the estimated locations of the hydrophone.

Example 9 includes the subject matter of Example 8, wherein the generating of the coarse estimate further comprises: sorting the pings based on maximum values of the incoherent cross correlations; estimating a seafloor range based on the maximum values; applying time delays to align the pings based on the estimated seafloor range; and sorting the aligned pings based on estimated distance to the seafloor.

Example 10 includes the subject matter of Examples 8 or 9, wherein the generating of the refined estimate further comprises: delaying groups of the coherently cross-correlated pings to a lag number corresponding to a maximum of the coherent cross-correlations; performing a second coherent cross-correlation between one of the sorted pings that is estimated closest to the seafloor, and a remainder of the sorted pings; and delaying the coherently cross-correlated pings to a lag number corresponding to a maximum of the second coherent cross-correlation.

Example 11 includes the subject matter of any of Examples 8-10, further comprising applying additional time delays to the pings to steer the beamformed signal in a desired direction.

Example 12 includes the subject matter of any of Examples 8-11, further comprising calculating a backscattering strength of the beamformed signal based on attenuation of the beamformed signal in water and range from the estimated locations of the hydrophone to a sediment surface from which the scattered returns are reflected and scattered.

Example 13 includes the subject matter of any of Examples 8-12, wherein the transmitted sonar signal is a frequency swept signal ranging from a first frequency to a second frequency.

Example 14 includes the subject matter of any of Examples 8-13, further comprising bandpass filtering the plurality of scattered returns of the transmitted signal to a frequency range between the first frequency and the second frequency.

Example 15 is at least one non-transitory computer readable storage medium having instructions encoded thereon that, when executed by one or more processors, cause a process to be carried out for implementing an end-fire synthetic aperture sonar, the process comprising: generating a plurality of matched filtered signals (pings) based on correlations of a transmitted sonar signal with a plurality of scattered returns of the transmitted signal received from a hydrophone, the scattered returns associated with a plurality of locations of the hydrophone relative to a location of a transmitter; generating a coarse estimate of the locations of the hydrophone based on incoherent cross correlations of the pings; generating a refined estimate of the locations of the hydrophone based on the coarse estimate and further based on coherent cross correlations of the pings; and performing delay-and-sum beamforming to combine the pings to generate a beamformed signal, the beamforming employing time delays based on the estimated locations of the hydrophone.

Example 16 includes the subject matter of Example 15, wherein the process further comprises: sorting the pings based on maximum values of the incoherent cross correlations; estimating a seafloor range based on the maximum values; applying time delays to align the pings based on the estimated seafloor range; and sorting the aligned pings based on estimated distance to the seafloor.

Example 17 includes the subject matter of Examples 15 or 16, wherein the process of generating the refined estimate further comprises: delaying groups of the coherently cross-correlated pings to a lag number corresponding to a maximum of the coherent cross-correlations; performing a second coherent cross-correlation between one of the sorted pings that is estimated closest to the seafloor, and a remainder of the sorted pings; and delaying the coherently cross-correlated pings to a lag number corresponding to a maximum of the second coherent cross-correlation.

Example 18 includes the subject matter of any of Examples 15-17, the process further comprising applying additional time delays to the pings to steer the beamformed signal in a desired direction.

Example 19 includes the subject matter of any of Examples 15-18, the process further comprising calculating a backscattering strength of the beamformed signal based on attenuation of the beamformed signal in water and range from the estimated locations of the hydrophone to a sediment surface from which the scattered returns are reflected and scattered.

Example 20 includes the subject matter of any of Examples 15-19, wherein the transmitted sonar signal is a frequency swept signal ranging from a first frequency to a second frequency, and the process further comprises bandpass filtering the plurality of scattered returns of the transmitted signal to a frequency range between the first frequency and the second frequency.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner, and may generally include any set of one or more elements as variously disclosed or otherwise demonstrated herein.

1. An end-fire synthetic aperture sonar system, the system comprising:
a matched filter circuit to generate a plurality of matched filtered signals (pings) based on correlations of a transmitted sonar signal with a plurality of scattered returns of the transmitted signal received from a hydrophone, the scattered returns associated with a plurality of locations of the hydrophone relative to a location of a transmitter;
a navigation circuit to generate a coarse estimate of the locations of the hydrophone based on incoherent cross correlations of the pings;
the navigation circuit further to generate a refined estimate of the locations of the hydrophone based on the coarse estimate and further based on coherent cross correlations of the pings; and
a delay-and-sum beamforming circuit to combine the pings to generate a beamformed signal, the beamforming employing time delays based on the estimated locations of the hydrophone.

2. The system of claim 1, wherein the coarse estimate generation further comprises:
sorting the pings based on maximum values of the incoherent cross correlations;
estimating a seafloor range based on the maximum values;
applying time delays to align the pings based on the estimated seafloor range; and
sorting the aligned pings based on estimated distance to the seafloor.

3. The system of claim 2, wherein the refined estimate generation further comprises:
delaying groups of the coherently cross-correlated pings to a lag number corresponding to a maximum of the coherent cross-correlations;
performing a second coherent cross-correlation between one of the sorted pings that is estimated closest to the seafloor, and a remainder of the sorted pings; and
delaying the coherently cross-correlated pings to a lag number corresponding to a maximum of the second coherent cross-correlation.

4. The system of claim 1, further comprising a beam-steering circuit to apply additional time delays to the pings to steer the beamformed signal in a desired direction.

5. The system of claim 1, further comprising an intensity-envelope calculation circuit to calculate a backscattering strength of the beamformed signal based on attenuation of the beamformed signal in water and range from the estimated locations of the hydrophone to a sediment surface from which the scattered returns are reflected and scattered.

6. The system of claim 1, wherein the transmitted sonar signal is a frequency swept signal ranging from a first frequency to a second frequency.

7. The system of claim 6, further comprising a bandpass filter circuit to filter the plurality of scattered returns of the transmitted signal to a frequency range between the first frequency and the second frequency.

8. A method for implementing an end-fire synthetic aperture sonar, the method comprising:
generating, by a processor-based system, a plurality of matched filtered signals (pings) based on correlations of a transmitted sonar signal with a plurality of scattered returns of the transmitted signal received from a hydrophone, the scattered returns associated with a plurality of locations of the hydrophone relative to a location of a transmitter;
generating, by the processor-based system, a coarse estimate of the locations of the hydrophone based on incoherent cross correlations of the pings;
generating, by the processor-based system, a refined estimate of the locations of the hydrophone based on the coarse estimate and further based on coherent cross correlations of the pings; and
performing, by the processor-based system, delay-and-sum beamforming to combine the pings to generate a beamformed signal, the beamforming employing time delays based on the estimated locations of the hydrophone.

9. The method of claim 8, wherein the generating of the coarse estimate further comprises:
sorting the pings based on maximum values of the incoherent cross correlations;
estimating a seafloor range based on the maximum values;
applying time delays to align the pings based on the estimated seafloor range; and
sorting the aligned pings based on estimated distance to the seafloor.

10. The method of claim 9, wherein the generating of the refined estimate further comprises:
delaying groups of the coherently cross-correlated pings to a lag number corresponding to a maximum of the coherent cross-correlations;
performing a second coherent cross-correlation between one of the sorted pings that is estimated closest to the seafloor, and a remainder of the sorted pings; and
delaying the coherently cross-correlated pings to a lag number corresponding to a maximum of the second coherent cross-correlation.

11. The method of claim 8, further comprising applying additional time delays to the pings to steer the beamformed signal in a desired direction.

12. The method of claim 8, further comprising calculating a backscattering strength of the beamformed signal based on attenuation of the beamformed signal in water and range from the estimated locations of the hydrophone to a sediment surface from which the scattered returns are reflected and scattered.

13. The method of claim 8, wherein the transmitted sonar signal is a frequency swept signal ranging from a first frequency to a second frequency.

14. The method of claim 13, further comprising bandpass filtering the plurality of scattered returns of the transmitted signal to a frequency range between the first frequency and the second frequency.

15. At least one non-transitory computer readable storage medium having instructions encoded thereon that, when executed by one or more processors, cause a process to be carried out for implementing an end-fire synthetic aperture sonar, the process comprising:
generating a plurality of matched filtered signals (pings) based on correlations of a transmitted sonar signal with a plurality of scattered returns of the transmitted signal received from a hydrophone, the scattered returns associated with a plurality of locations of the hydrophone relative to a location of a transmitter;
generating a coarse estimate of the locations of the hydrophone based on incoherent cross correlations of the pings;
generating a refined estimate of the locations of the hydrophone based on the coarse estimate and further based on coherent cross correlations of the pings; and
performing delay-and-sum beamforming to combine the pings to generate a beamformed signal, the beamforming employing time delays based on the estimated locations of the hydrophone.

16. The computer readable storage medium of claim 15, wherein the process further comprises:
sorting the pings based on maximum values of the incoherent cross correlations;
estimating a seafloor range based on the maximum values;
applying time delays to align the pings based on the estimated seafloor range; and
sorting the aligned pings based on estimated distance to the seafloor.

17. The computer readable storage medium of claim 16, wherein the process of generating the refined estimate further comprises:
delaying groups of the coherently cross-correlated pings to a lag number corresponding to a maximum of the coherent cross-correlations;
performing a second coherent cross-correlation between one of the sorted pings that is estimated closest to the seafloor, and a remainder of the sorted pings; and
delaying the coherently cross-correlated pings to a lag number corresponding to a maximum of the second coherent cross-correlation.

18. The computer readable storage medium of claim 15, the process further comprising applying additional time delays to the pings to steer the beamformed signal in a desired direction.

19. The computer readable storage medium of claim 15, the process further comprising calculating a backscattering strength of the beamformed signal based on attenuation of the beamformed signal in water and range from the estimated locations of the hydrophone to a sediment surface from which the scattered returns are reflected and scattered.

20. The computer readable storage medium of claim 15, wherein the transmitted sonar signal is a frequency swept signal ranging from a first frequency to a second frequency, and the process further comprises bandpass filtering the plurality of scattered returns of the transmitted signal to a frequency range between the first frequency and the second frequency.
